(19) United States
(12) Patent Application Publication
(10) Pub. No.: US 2005/0132104 A1
(43) Pub. Date: Jun. 16, 2005

(54) Command processing systems and methods

(76) Inventor: David W. Brown, Bingen, WA (US)

Correspondence Address: SCHACHT LAW OFFICE, INC., SUITE 202, 2801 MERIDIAN STREET, BELLINGHAM, WA, 98225-2412, US

(21) Appl. No.: 10/991,905

(22) Filed: Nov. 17, 2004

Related U.S. Application Data
(60) Provisional application No. 60/520,918, filed on Nov. 17, 2003.

(51) Int. Cl. G06F 3/00

(52) U.S. Cl. 710/36

(57) ABSTRACT

A command processing system for transferring commands from at least one command source to at least one command target of at least one command target type. The command processing system comprises at least one service client associated with each command source; a command processor in communication with the at least one service client; and a command thread associated with each command target type. The command thread is in communication with the command processor. The command thread is in communication with the at least one command target. The command thread transfers commands from the command processor to the command target.

### RELATED APPLICATIONS

The present application claims priority of U.S. Provisional Patent Application Ser. No. 60/520,918 filed on Nov. 17, 2003.

### FIELD OF INVENTION

The present invention relates to systems and methods of distributing software commands and, more specifically, such software systems and methods for distributing commands from one or more command sources to one or more command targets.

### BACKGROUND OF INVENTION

The present invention is of particular significance in the field of motion control systems and methods, and that application of the present invention will be described in detail herein. However, the present invention may have broader application to other systems and methods in which commands from one or more command sources must be distributed to one or more command targets.

In the context of motion control systems, control commands are transmitted to motion control devices such as computer numeric control (CNC) systems, general motion control (GMC) automation systems, and hardware independent data engines for motion control systems. The destination motion control device will be referred to herein as a command target. In some situations, these control commands come from a variety of sources, which will be referred to herein as command sources.

The need exists for systems and methods for organizing the distribution of control commands form a variety of types of command sources to a variety of types of command targets.

### SUMMARY OF INVENTION

The present invention may be embodied as a command processing system for transferring commands from at least one command source to at least one command target of at least one command target type. The command processing system comprises at least one service client associated with each command source; a command processor in communication with the at least one service client; and a command thread associated with each command target type. The command thread is in communication with the command processor. The command thread is in communication with the at least one command target. The command thread transfers commands from the command processor to the command target.

### DETAILED DESCRIPTION OF THE DRAWINGS

FIG. 1 is a module interaction map depicting the interaction of modules of a command processor system of a first embodiment of the present invention;

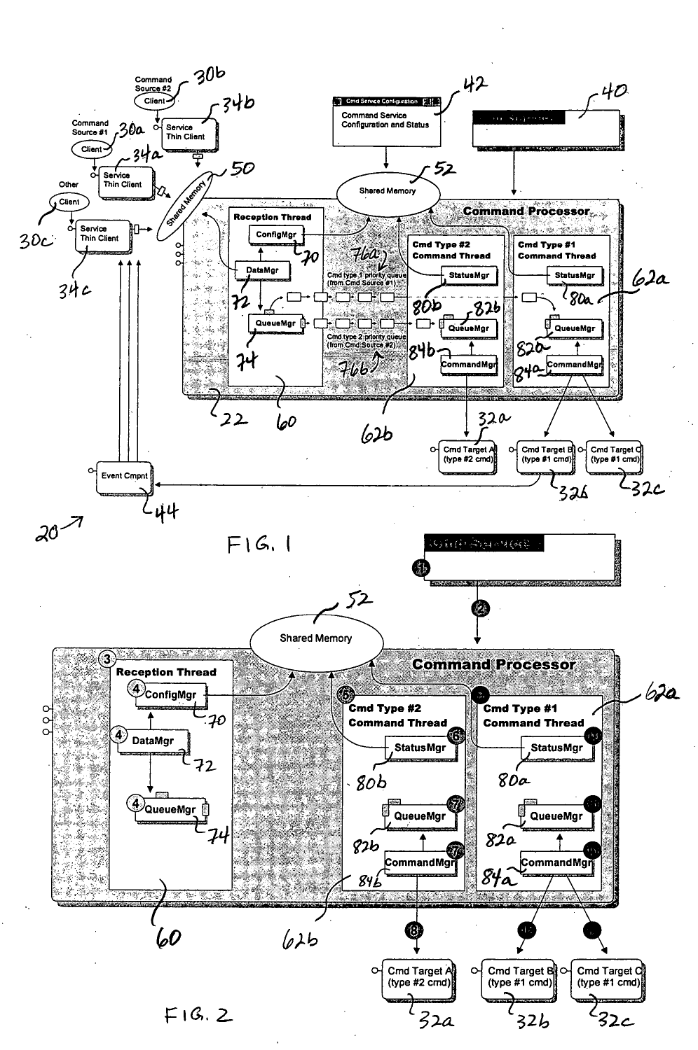

FIGS. 2-8 are use case maps illustrating common uses cases that occur during operation of the example command processing system of FIG. 1;

FIG. 9 is a module interaction map depicting the interaction of modules of a command processor system of a second embodiment of the present invention;

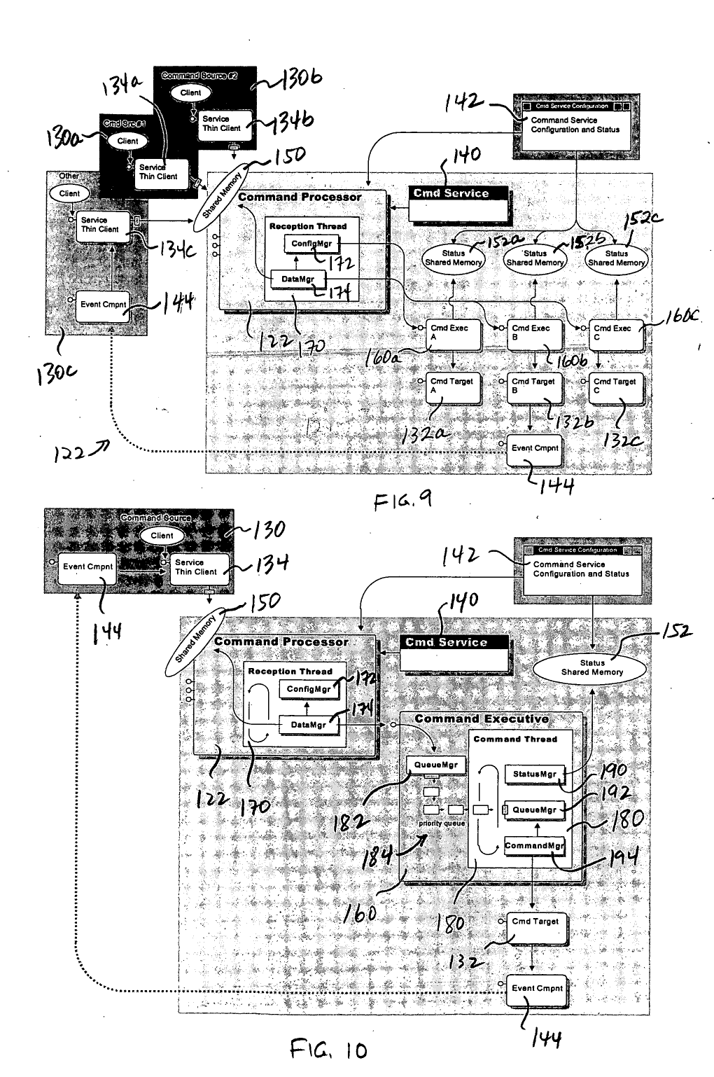

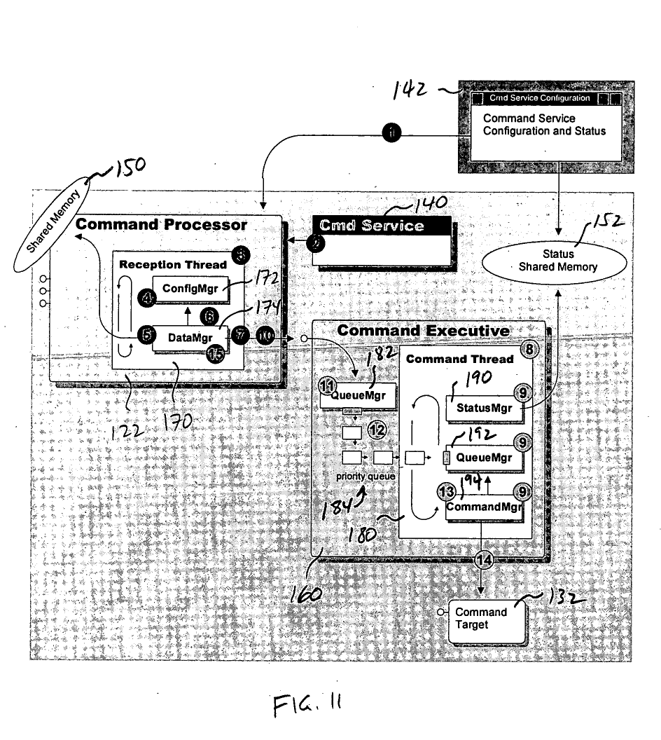

FIGS. 10-14 are use case maps illustrating common uses cases that occur during operation of the example command processing system of FIG. 9; and

FIG. 15 depicts a component interface implemented by all components of the example command processing system of FIG. 9.

### DETAILED DESCRIPTION OF THE INVENTION

The present invention relates to systems and methods for processing various types of commands transmitted between one or more command sources and one or more command targets forming part of a larger command system. The present invention is of particular significance when the command system is part of a motion control system, and that application will be referred to on occasion below. As used herein, the term “command” refers to information that allows an operation to be executed on a command target.

The present invention may be implemented using any one or more of a number of different system designs. A self contained system 20 of the present invention will be described below with reference to FIGS. 1-8. The self contained system 20 describes a command processor component that implements all command processing functionality within a single component. A modular design will be described with reference to FIGS. 9-14. The modular design describes a a command processor system made up of the command processor component and one or more command execution components. The example self contained and modular designs are described below with reference to a module interaction description and a set of use cases that describe how the modules interact with one another when carrying out common operations.

In the present application, the term “module” is used to refer to a binary block of computer logic that contains functions, objects, components, ActiveX components, .NET source, HTML, XML and/or other computer code that can be executed in real-time or in script form. Several examples of a module include an executable EXE, a dynamic link library DLL, an OLE component or set of components housed within a DLL or EXE, an ActiveX Control, an HTML or XML based Control, a VB script source file, a Java Serverlet, Java Control, Java Object, NET Package, etc. The term “component” as used herein refers to a logical organization of computer logic designed to perform a set of operations. Several examples of a component are an OLE Component, an ActiveX Control, an HTML or XML based Control, an HTML or XML based object, a .NET object, a Visual Basic based object, etc.

Referring now to FIG. 1 of the drawing, depicted therein at 20 is a command processing system constructed in accordance with the principles of a self contained system 20 of the present invention. The self contained system 20 comprises a command processor 22 implemented such that all command processing takes place within a single component. The self contained system 20 may allow for faster command processing than command processing systems using alternative designs.

The command processor 22 is designed to run as an individual COM+ Component either in a stand alone manner under COM+. In the context of a motion system, the command processor 22 may be designed to operate under a Windows NT Service application for providing motion services (e.g., XMC Service). When run under COM+, the command processor 22 may receive commands in various forms, including SOAP (simple object architecture protocol), Web Services, COM method calls, and by monitoring a section of shared memory for command requests. Various other command input methods may also employed.

The example command processing system 20 comprises the command processor component 22, one or more command source components 30, and one or more command target components 32. The example command sources 30 are each associated with a service client 34. The example command processing system 20 further comprises a command service module 40 and a command service configuration and status module (configuration and status module) 42. In some situations, the command processing system 20 may further comprise an event component 44.

The example command processor 22 receives, runs, and responds to commands received through first and second areas 50 and 52 of shared memory in the system 20. The command processor may optionally run as a COM+ component that services SOAP or other Web Service requests directly or via COM+. The command processor 22 may optionally communicate with the command target components 32 across a network, depending on the overall system architecture. As used herein, the term “network” refers to a link between two or more computer systems and may be in the form of a packet based network, a streaming based network, broadcast based network, or peer-to-peer based network. Several network examples include a TCP/IP network, the Internet, an Intranet, a wireless network using WiFi, a wireless network using radio waves and/or other light based signals, etc.

If the sent commands relate to a command operation that must run as a set of commands or not at all, the command processor 22 may employ command ‘framing’ to ensure that the commands are run as a set. U.S. Pat. No. 6,480,896 to the present Applicant describes a system of command framing in the context of a motion control system.

The example service clients 34 are thin service components associated with specific clients or types of clients that interface with the shared memory used to communicate command requests to the command processor 22. Each service client 34 may also relay input to the command processor 22 by receiving commands via some other protocol such as TCP/IP, SOAP Messaging, or the like that is transferred either locally or across a network. Once received, the command is then converted into the appropriate shared memory format to direct the command processor 22 that a new command is ready for processing. Optionally the service client 34 may communicate either locally or across a network using OLE/COM interface methods of the command processor 22. This method is typically not as fast, but can allow for architectural flexibility.

In the context of a motion control system, the command sources 30 may be formed by an application programming interface for motion systems 30a (e.g., XMC API), a system for processing data 30b (e.g., XMC Data Router), and/or other clients 30c.

The command targets 32 are sets of components used to monitor devices or machines. Each of the command targets 32 may be created for particular device or machine or class of devices or machines. The terms “device” or “machine” as used herein refer to a physical asset used to perform a specified task. For example, a machine may be a CNC Mill used to shape metal, a pick-n-place machine used to position parts on a circuit board, a robotic machine used to perform surgery, a medical data input device used to collect the vitals from a human being (i.e. blood glucose meter, asthma meter, etc), a gaming device used when playing a game, a robotic toy, an animatronics figure, a robotic machine used to deliver goods to a warehouse or to people, an automobile, truck or farm vehicle, a boat or ship that maneuvers in water, a airplane, jet, helicopter and/or spacecraft. Basically any self powered machine or device (mobile or not) that is either directly controlled by humans or automatically controlled via a computer based system.

In the context of a motion control system, the command targets may be formed by a system of transmitting data to a motion system (data engine) 34a (e.g., XMCDE Data Engine system), a system for automating control of a CNC motion system (CNC control system) 34b (e.g., XMC CNC Automation system), and/or a system for automating control of a GMC motion system (GMC control system) 34c (e.g., XMC GMC Automation system).

The configuration and status module 42 allows the user to configure the service and gain status on how the application is running. The example command service module 42 is a very thin Windows NT Service that optionally hosts the command processor 22, thereby allowing the command processor to run even while the current user is not logged into the system.

The event component 44 sends event data received from one of the data sources formed by the target components 32 to one or more ‘listening’ client components 34 associated with the command sources 30. The term “data” as used herein refers to any numeric or string data values collected from a target machine or device in an analog or digital format that is made compatible for computer systems. Examples of data types that represent data items include BIT, BYTE, WORD, DWORD, LONG, REAL, DOUBLE, FLOAT, STRING, ASCII STRING. Data may be collected from data sources using various methods such as reading register values on the data source, reading shared memory provided by the data source, sending commands to the data source for which a data response is given containing the data requested, reading variables provided by the data source, reading and writing to variables in a sequence necessary to produce data values, querying data using a proprietary or standard data protocol, and/or calling a function provided by the target data source.

As shown in FIG. 1, the example command processor 22 comprises several C++ objects and Windows NT threads that interact with one another to route the commands received to the appropriate target components that ultimately carry out the specifics of the command requested. In particular, the example command processor 22 comprises a reception thread 60 and one or more command threads 62.

The reception thread 60 is responsible for receiving commands placed in the shared memory 52. The reception thread 60 continually scans the shared memory 52 for new commands triggered by the use of global events.

In the context of a motion control system, the command threads 62 are of two types, where a first command thread 62a processes commands associated with the data engine 34a and the second command thread 62b processes commands associated with the CNC motion system 34b and the GMC motion system 34c.

The following C++ objects are used to implement portions of the example command processor 22.

The reception thread 60 comprises a ConfigMgr object 70, a DataMgr object 72, and a QueueMgr object 74. The ConfigMgr object 70 accesses configuration information placed in the shared memory area 52 by the configuration and status module 42. The DataMgr 72 pulls commands from the memory area 50 shared with the service clients 34. The example QueueMgr object 74 manages one or more priority queues 76 servicing the command threads 62.

The command threads 62 each comprise a StatusMgr object 80, a QueueMgr object 82, and a CommandMgr object 84. The StatusMgr object 80 is manages and updates the status area 52 of the shared memory used by the configuration and status module 42. The status information managed and updated by the StatusMgr object 80 may be displayed to provide a user with visual feedback on what the command threads 62 are actually doing at each point in time, as well as the number of elements in the command queues. The CommandMgr object 84 carries out each command by calling the appropriate target components 32.

The interaction of the objects, threads and components forming the command processor 22 will now be described in several common use cases. The following use cases will be described below: Initialization, System Start, Command Processing (First Command Thread), Command Processing (Second Command Thread), Receiving Data, and Receiving Events. The steps making up each use case are described in the order in which they occur.

Referring now to FIG. 2, the Initialization use case will first be described. Initialization takes place when an application, such as the command services application 40, first starts up and loads the command processor 22. During this process each of the threads are started and all C++ objects are initialized.

The following steps take place when initializing the command processor 22. In step 1, the application hosting the command processor 22, such as the XMC Windows NT Service or COM+DLLHOST, starts up. In step 2, the host application creates the component forming the command processor 22. When first created, the component forming the command processor 22 creates and starts the reception thread 60 in step 3. In step 4, ConfigMgr, DataMgr and QueueMgr objects 70, 72, and 74 used by the reception thread 60 are created and initialized.

In step 5, the second command thread 62b is created and started. In step 6, an instance of the StatusMgr object 80b is created and initialized. Once created, this component 80b may be used to update status information on the overall initialization process. In step 7, instances of the QueueMgr and CommandMgr objects 82b and 84b are created and initialized. In step 8, the CommandMgr object 84b creates an instance of its associated target component 32a.

In step 9, the command thread or threads 62 are created and started. In step 10, an instance of the StatusMgr object 80a is created and initialized, allowing status information on the initialization progress of the command thread 62a to be set. In step 11, an instance of the CommandMgr and QueueMgr objects 82a and 84a used by the thread 62a are created and initialized.

At step 12, the CommandMgr creates an instance of the command targets 32b and 32c. In the context of a motion control system, a multi-system configuration may optionally use separate threads to process CNC and GMC commands respectively.

After completing the initialization, the reception thread 60 places itself in the ‘paused’ state so that it will not process any commands until resumed. At this point the command processor 22 is initialized and ready to be started.

Once initialized, the reception thread 60 must be resumed from its paused state prior to use of the system 20. No commands are processed until the reception thread 60 is resumed.

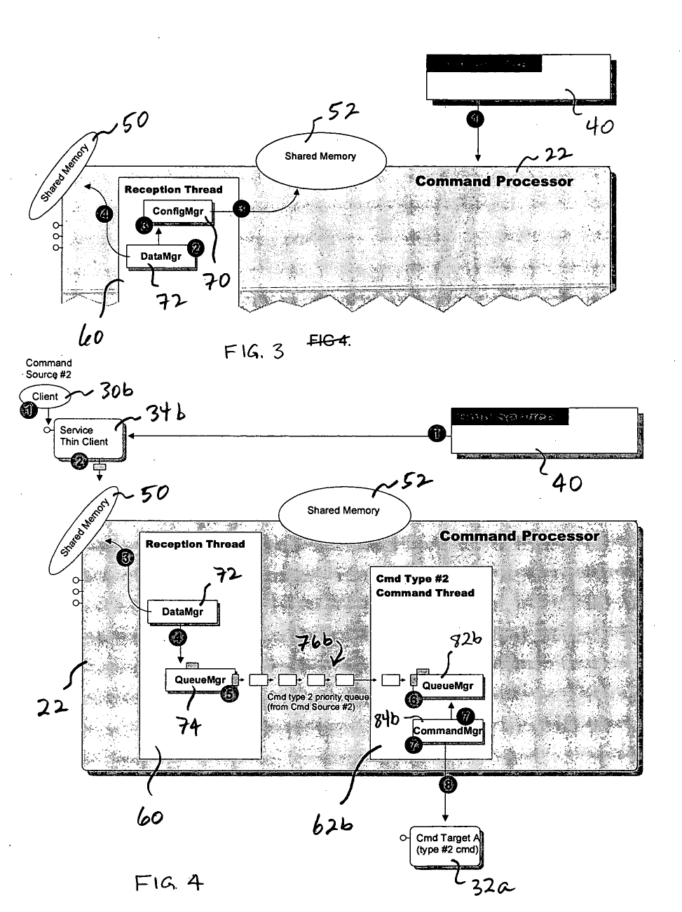

Referring now to FIG. 3, the following steps occur when starting the command processor 22. In step 1, the hosting command service application 40 calls a method on the command processor 22 component to ‘start’ the command processing. In step 2, upon receiving the ‘start’ call, the command processor 22 component resumes the reception thread 60 causing the DataMgr object 72 to first query for any configuration changes.

In step 3, the DataMgr object 72 queries the ConfigMgr object 74 for any configuration changes such as a new priority for the reception thread 60, etc. The ConfigMgr object 70 queries the configuration shared memory for any settings. Once started as shown at step 4, the DataMgr object 72 resumes normal operation and continually checks for new commands in the shared memory.

At this point all commands received are processed normally. The following sections describe how two of the main command types are processed; namely the example command threads 62a and 62b.

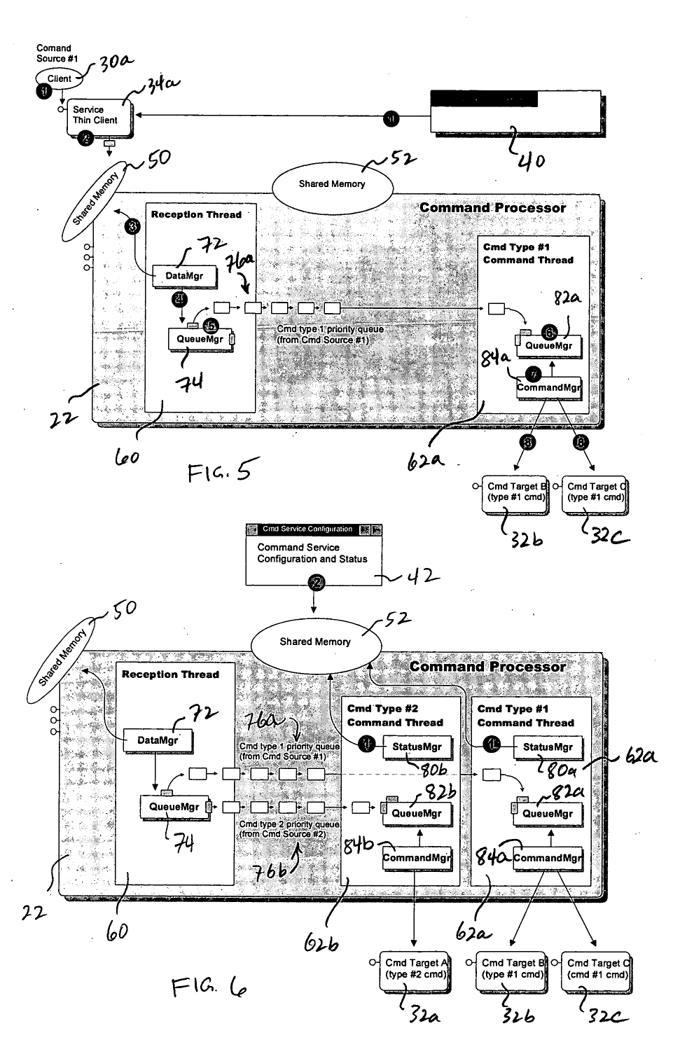

Referring first to FIG. 4, depicted therein is the processing implemented by the second type of command thread 62b. In general, all commands associated with the command target 32a are processed are routed to the first command target 32a. Examples of the commands sent to the command target 32a are ‘Start’ or ‘Pause’ and these commands will be referred to as first type commands.

The following steps occur when processing commands destined for the command target 32a. In step 1, the command source 30b calls the service client 34b requesting that a given first type command be run. As generally discussed above, some commands may be initiated by the host itself, a user interface application, or even a protocol listener used to convert and route command 30 requests using the service client 34b.

In step 2, the service client 34b packages the command into an area within the shared memory area 50 specifically allocated for that instance of the service client 34b. Within the command processor 22, the reception thread 60 is continually monitoring the shared memory 50 for new commands as shown in step 3. Upon detecting a new command, the DataMgr object 72 extracts the command information from the shared memory area 50.

In step 4, the DataMgr object 72 passes the command information to the QueueMgr object 74. In step 5, the QueueMgr object 74 packages the command information into a queue command element and places the command in the priority queue 76b. The element may be placed at a location in the queue based on the element's priority so that high priority commands are processed sooner than low priority commands.

Within the command threads 62, the QueueMgr object 74 implicitly receives the queued command (i.e. it is the same queue accessed in the reception thread 60) as shown in step 6.

As shown in step 7, the CommandMgr object 84b, which continually checks for new commands to run in the command thread 62b, detects a new command and pulls it from the QueueMgr object 82b. And finally in step 8, the CommandMgr object directs the command to the command target component 32a, which carries out the requested command.

At this point the command is complete. However, the mechanism just described does not allow notification back to the service client 34b that requested the command. This type of command is known as a ‘broadcasted’ command, where the command is sent without sending back status on the results of the command carried out.

As shown in FIG. 5, the first command thread 62a operates in a manner similar to that of the second command thread 62b, except that commands routed through the first command thread 62a are routed to one of the command targets 32b and 32c instead of the command target 32a.

The following steps occur when processing commands destined for the command targets 32b and 32c.

In step 1, the service client 30 calls the Service Thin Client requesting to run a given first type command. Again, some commands may be initiated by the host itself, a user interface application, or even a protocol listener used to convert and route command requests using the service client 34.

In step 2, the service client 34a packages the command into the area within the shared memory area 50 specifically allocated for that instance of the service client 34a.

Within the command processor 22, the reception thread 60 is continually monitoring the shared memory for new commands as shown in step 3. Upon detecting a new command, the DataMgr object 72 extracts the command information from the shared memory.

As shown in step 4, the DataMgr object 72 passes the command information to the QueueMgr object 74. At step 5, the QueueMgr object 74 packages the command information into a queue command element and places the command in the priority queue 76a. The element may be placed at a location in the queue based on the elements priority so that high priority commands are processed sooner than low priority commands.

As shown at step 6, within the command thread 62a, the QueueMgr object 82a implicitly receives the queued command (i.e. it is the same queue accessed in the reception thread 60).

At step 7, the CommandMgr object 84a, which continually checks for new commands to run in the command thread 62a, detects a new command and pulls it from the QueueMgr object 82a.

And finally at step 8, the CommandMgr object 84a directs the command to the command target component 32b and/or 32c which carries out the requested command.

At this point the command is complete. Again, no notification is sent back to the service client 34 who requested the command. This example command is known as a ‘broadcasted’ command where the command is sent without sending back status on the results of the command carried out.

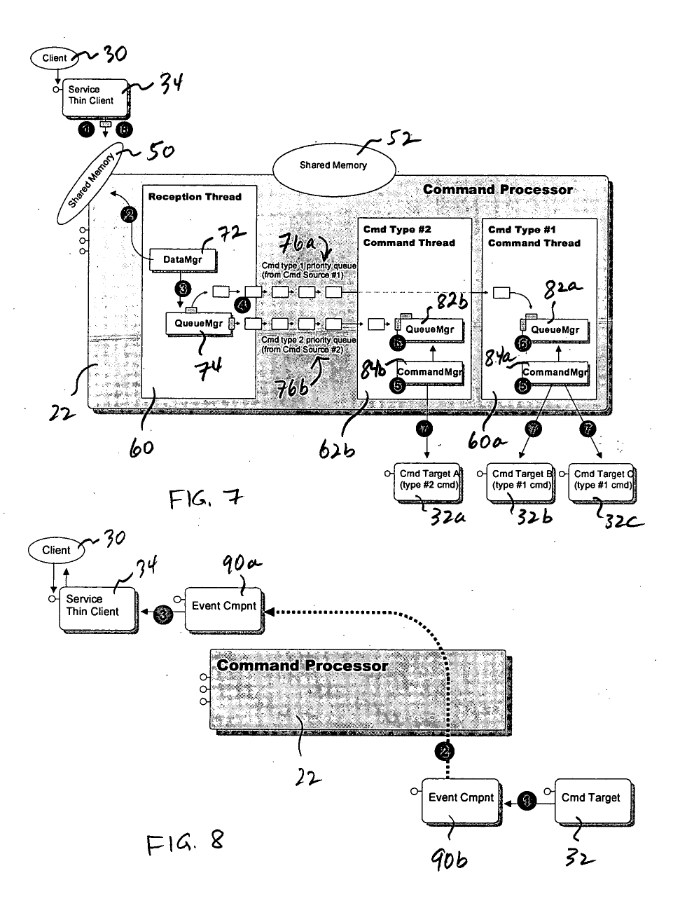

While running the command processor 22, often it is important to display visual feedback on what the command processor 22 is actually doing. For example, the user may want to know whether the command processor 22 is currently processing a command or how many commands are in the various command queues. The use case illustrated in FIG. 6 illustrates how such user feedback can be attained while running the command processor 22.

The following steps occur when updating status while processing each command.

In a step 1, the StatusMgr objects 80a and 80b collect status information while each of the command threads 62a and 62b run. All status information is saved to the status/configuration shared memory area 52.

In step 2, each application requesting status information reads the shared memory area 52 where the status information was placed.

The service client 34 that requested a command be run will want or need feedback on the results of the command and in many cases data that results from running the command. The use case depicted in FIG. 7 describes how feedback data may be returned to service clients 34.

The following steps occur when data and results are to be returned to the service client 34.

In step 1, the service client 34 places the command into the shared memory area 50. Included with the command information is the name of the global event for which the service client 34 is waiting and which should be set by the command processor 22 upon completion of the command.

As shown in step 2, upon receiving the command, the DataMgr object 72 extracts the command information from the shared memory area 50, including the name of the global event. At step 3, all command information is passed to the. QueueMgr object 74.

As shown at step 4, the QueueMgr object 74 packages the command information into a command element that is then placed within the appropriate command priority queue 76a and/or 76b.

In step 5, the CommandMgr objects 84 within the command threads 62 detect the command by querying the QueueMgr object 82b. In step 6, the QueueMgr objects 82 return the command element or elements to the CommandMgr objects 84.

In step 7, the CommandMgr objects 84 run the command by delegating it to the appropriate command target 32. Upon completion of the command, the CommandMgr objects 84 update the shared memory 52 referenced by the command element with the return result and any data returned by the command targets 32. Once all data is updated, the CommandMgr objects 84 set the global event referenced by the command element, notifying other components of the command processor 22 that execution of the command is complete.

In step 8, the event that the service client 34 is waiting on is released, thus freeing the service client 34 to continue with the data placed in the shared memory area 52 back in step 7. At this point the command processing for the command is complete.

In some cases, it is desirable for the service client 34 to receive ‘unsolicited’ updates when certain events occur. FIG. 8 depicts the situation in which the service client 34 receives updates upon the occurrence of certain events. To receive events, the event component 44 is accessible by the command client 34 and the command target 32. In addition, the service client 34 calls a command source 30 to ‘subscribe’ to the event. Once subscribed, the event is fired to the service client 34 when the event condition is met. The following steps occur when events are sent back to the service client 34.

In a first step, when the event condition is met, the component that is the source of the event fires the event using the event component 44. In step 2, the event component 44 sends the ‘global’ event to all instances of the event component 44. In step 3, the instance of the event component 44 used by the service client 34 picks up the event and calls an event handler on the service client 34. At this point the event routing has completed.

Referring now to FIGS. 9-14, a modular design of a command processing system 120 of the present invention will now be described. The command processing system 120 comprises command processor 122. The command processing system 120 is more scaleable than the command processing system 20 described above in that it can support any type of command without requiring any changes within the command processor 122.

In general, two component types interact with one another to process commands received: the command processor 122 and a number of command execution components that will be described in further detail below. As with the system 20 described above, the system 120 transfers commands between one or more command sources 130 and one or more command targets 132. Each command source 130 is associated with a service client 134. The system 120 further comprises a command services module 140 and a configuration and status module 142. The system 120 further defines shared memory areas 150 and 152a, 152b, and 152c.

To process commands, the command processor 122 routes each command received to an appropriate command execution component 160 designated to handle the type of command received.

Optionally, each of the command execution components 160 may be given a global priority that dictates how and when the command processor 122 sends commands thereto. For example, FIG. 1 shows how three different types of commands associated with three types of command targets 132a, 132b, and 132c may be supported. The design is specifically intended to support many different kinds of commands, including commands not yet defined by the command implementer of the command processor 122 and/or commands defined by a third party. The design of the command processing system 120 thus allows for supporting many different types of commands without requiring changes in the overall command processor 22 architecture. Another advantage of the design of the command processing system 120 is that this design allows for the deployment of new command types to the field where the command processor 22 is already in use.

FIG. 10 is a slightly more detailed block diagram illustrating the command processor 122 and each command execution components 160.

The service client 134 functions as an interface between a shared memory area 150 and is used to communicate command requests to the command processor 22. The service clients 134 may also be used to relay input to the command processor 22 by receiving command via some other protocol such as TCP/IP, SOAP Messaging, etc., that is transferred either locally or across a network. Once received, the command is then converted into the appropriate shared memory format to direct the command processor 22 that a new command is ready for processing. Optionally, the service client 134 may communicate either locally or across a network using the OLE/COM interface methods of the components forming the command processor 122. This method is not as fast, but can allow for architectural flexibility.

The command processor component 122 receives and delegates each command to the appropriate command execution component 160. The command processor component 122 may also run optionally as a COM+ component that services SOAP or other Web Service requests, either directly or via COM+. Optionally, the command processor 122 may communicate with the command execution components 160 across a network.

Command execution components 160 are responsible for running the set of commands associated with the component. For example, individual command execution components 160a, 160b, and 160c run commands that are destined for the target component 132a, 132b, and 132c, respectively. Optionally each individual command execution component 160 may run as a COM+ component. Again, this may not optimize system speed, but can provide desirable architectural flexibility.

The command execution components 160 may support using Artificial Intelligence to break down generic commands into a set of more complex commands used to carry out a task. As used herein, the term “artificial intelligence” refers to algorithms such as Neural Networks, Genetic Algorithms, Fuzzy Logic, Expert Systems, combinations of all listed and other computer based decision making and pattern matching based systems. For example, a generic command may state to lift up a box. This command would then be broken down into the sequence of moves given the current position of a loader arm, necessary to pick up the box. The command execution component 160 may use Artificial Intelligence to do such a breakdown.

When communicating to the target component 132, the command execution component 160 may do so either locally or across a network depending on the overall system architecture. In the event that the commands sent contain a critical operation that must run as a set of commands or not at all, the command processor may employ a form of command ‘framing’ as generally described above.

The example command service component 140 is a very thin Windows NT Service that optionally hosts the command processor 122 thus allowing the command processor to run even while the current user is not logged into the system. It should be noted that future versions may not need this service as COM+ supports running components as a services. Since the command processor component 122 optionally supports COM+ it may also be run as a service in COM+.

The configuration and status module application 142 allows the user to configure the command processor 122 and various command execution components 160 and obtain status on how each component is running.

The command targets 132 are or may be similar to the command targets 32 described above, and the command targets 132 will not be described again herein beyond what is necessary for a complete understanding of the present invention.

Like the event component 44 described above, the event component 44; sends event data received from one of the various command targets 132 to one or more ‘listening’ service clients 134.

The details of the example command processor 122 will now be described in detail. The example command processor 122 comprises several C++ objects and a Windows NT thread that interact with one another to route the commands received to the appropriate command execution component 160.

The command process comprises a reception thread 170 that receives commands placed in the shared memory area 150. The thread 170 continually scans for new commands in the shared memory area 150. The new commands may be triggered by the use of global events.

The following example objects are C++ objects used to implement portions of the command processor 122. A ConfigMgr object 172 pulls configuration information set in the shared memory area 150 by the configuration and status module 142. A DataMgr object 174 pulls commands,:stored by the service client 134 in the shared memory area 150.

The command execution components will now be described in further detail. Within the command execution component 160 several C++ objects and a Windows NT thread interact with one another to run the commands received.

Each command execution component 160 comprises a command thread 180. The command threads 180 process commands destined for the command target 132 that supports the command set associated with the command execution component 160.

The following C++ objects are used to implement portions of the command execution component 160. A QueueMgr object 182 is responsible for managing the various priority queues 184 servicing the command threads 162.

A StatusMgr object 190 manages and updates the status area of the shared memory used by the configuration and status module 142. The status information updated is used to allow visual feedback on the state of the command threads 62 as well as the number of elements in the command queues 184.

A CommandMgr object 192 carries out each command by calling the appropriate command targets 132.

The interaction of the objects, threads and components of the command processing system 120 will now be described in reference to several common use cases that take place on the command processor 122 during normal use. The following use cases will be described in detail below: Initialization, Command Processing, Receiving Events, and Updating Status.

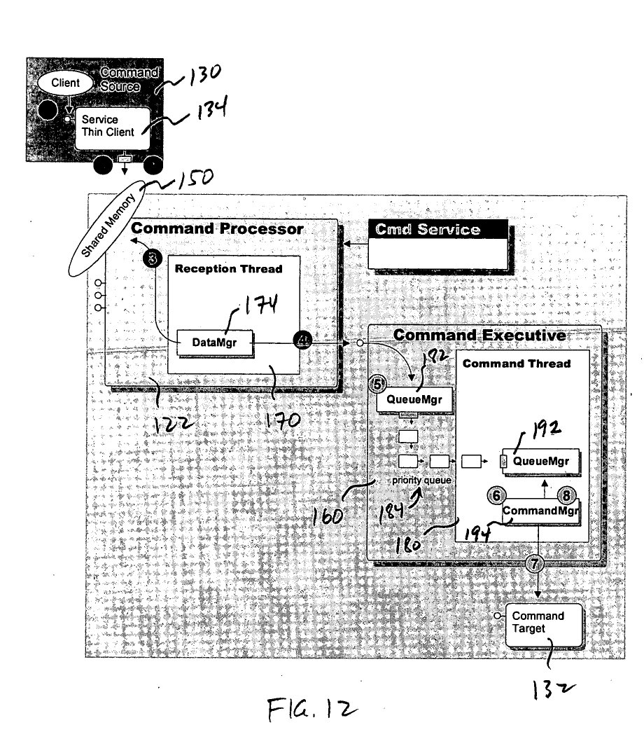

As shown in FIG. 11, when initializing the system, the following steps take place. In step 1, before actually starting the initialization of the component, the user may optionally change the configuration of the component using the configuration and status application 142, which allows the user to configure the command processor 122 and/or all command execution components 160.

At step 2, when actually initializing the component, the command target 132 (optionally a DLLHOST used when run as a COM+ server) creates the command processor component 122 and directs it to initialize itself.

At step 3, when created, the command processor 122 creates the reception thread 60 and runs it. Within the reception thread 60 the ConfigMgr is initialized at step 4. At step 5, the reception thread 60 initializes the DataMgr object 174.

During its initialization, the DataMgr object 174 queries the ConfigMgr object 172 for settings previously made by the user. For example, the list of command execution components 160 installed is queried.

At step 7, the DataMgr object 174 then creates each command execution component 160. When created, each command execution component 160 creates its command thread 180 and starts running it at step 8. Within the command thread 180, the StatusMgr, QueueMgr and CommandMgr objects are next initialized at step 9.

Upon completion of the command execution component 160 creation, at step 10 the DataMgr object 174 within the reception thread 170 of the command processor 122 sends a command to the command execution component 160 directing the execution component 160 to initialize itself.

At step 11, the initialization command is received by the QueueMgr object 192 in the command execution component 160. At step 12, the QueueMgr object 192 immediately places the command received into the command queue 184.

Within the command thread 180 of the command execution component 160, at step 13 the CommandMgr object 194 queries the QueueMgr object 192 for any new commands and pulls the initialize command from the queue (previously placed in the queue in step 12 above).

The CommandMgr object 194 creates the appropriate command target 132 at step 14, which runs the commands in the set associated with the specific command execution component 160. The command target 132 is also directed to initialize itself making it ready to process commands. Upon completing the initialization, the CommandMgr 194 unlocks the Windows Event associated with the command signifying that the command has been completed.

Referring back to the DataMgr object 174 within the reception thread 170 in the command processor component 122, the DataMgr object 174 detects that the command has been completed and prepares to run more commands as shown at step 15.

The creation process, in which the command processor 122 and command execution components 160 are created, and the initialization process may optionally be separated. In this case, a specific command is first created and then a specific ‘initialize’ command is then sent to the command processor directing it to prepare for receiving commands. In such a situation, the command processor 122 could block (wait until the initialization command completed) and then return the results of the initialization back to the configuration and status application 142 (or other host, such as DLLHOST, or a service client 134 using DLLHOST).

At this point the command processor 122 is running and ready to process commands from the service client or clients 34.

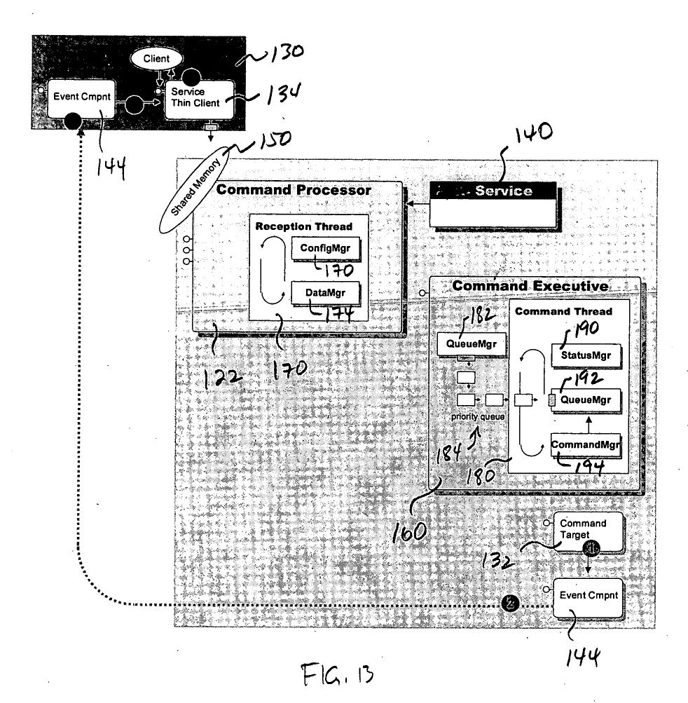

Referring now to FIG. 12, the following steps take place when processing a given command. In step 1, the service client 134 software calls the service client 134 directing it to run a given command.

In the step 2, the service client 134 then places the command information into the shared memory area 150 designated by the command processor 122 for the specific instance of the service client 134 (this designation occurs when first creating the service client 134). Optionally, the service client 134 then waits for the command processor 122 to signal that the event has completed. This signaling occurs either through information passed through the shared memory or with a global synchronization object, like a Windows NT Event object.

In step 3, the DataMgr object 174 of the reception thread 170 in the command processor 122 detects that a command is ready in the shared memory 150. The command information is extracted from the shared memory 150.

In step 4, the DataMgr object 174 sends the command information to the command execution component 160.

Upon receiving the command information, the information is routed to the QueueMgr 192 which then places the command information into the command queue at step 5. Optionally, the command information is placed into the queue 184 at a location specified by the command priority. For example, a high priority command may be placed at the beginning of the queue (i.e. pulled off the queue first) whereas a low priority command may be placed at the end of the queue (i.e. pulled off the queue last).

In step 6, the CommandMgr 194 within the command thread 180 queries the QueueMgr 192 for any commands that may exist and, if one does exist, pulls the command from the front of the command queue 184.

The command is then run at step 7 by passing the command to the command target 132 used to run the command. For example, second type command might be passed to the second command target 160b.

At step 8, upon completion of the command, the CommandMgr 194 copies all return data into the shared memory 150 and then either toggles information in the shared memory 150 associated with the command or signals a synchronization object, such as a Windows NT Event, to signify that the command has completed.

In step 9, the service client 134 detects that the command has completed and picks up any return data placed in the shared memory 150 and returns it to the command source 30.

At this point the command processing has completed.

Referring now to FIG. 13, the following steps occur when the service client 134 receives unsolicited events from the command target 132.

When the event condition is met (the event condition being previously configured), the command target 132 fires the event using the event component 144 as shown in step 1. In step 2, the event component 144 fires the event to all listening components including other instances of the event component 144. In step 3, the instance of the event component 144 used by the service client 134 picks up the event and routes it to the service client 134. The service client 134 then routes the event information to the command source 130.

At this point the event processing is complete.

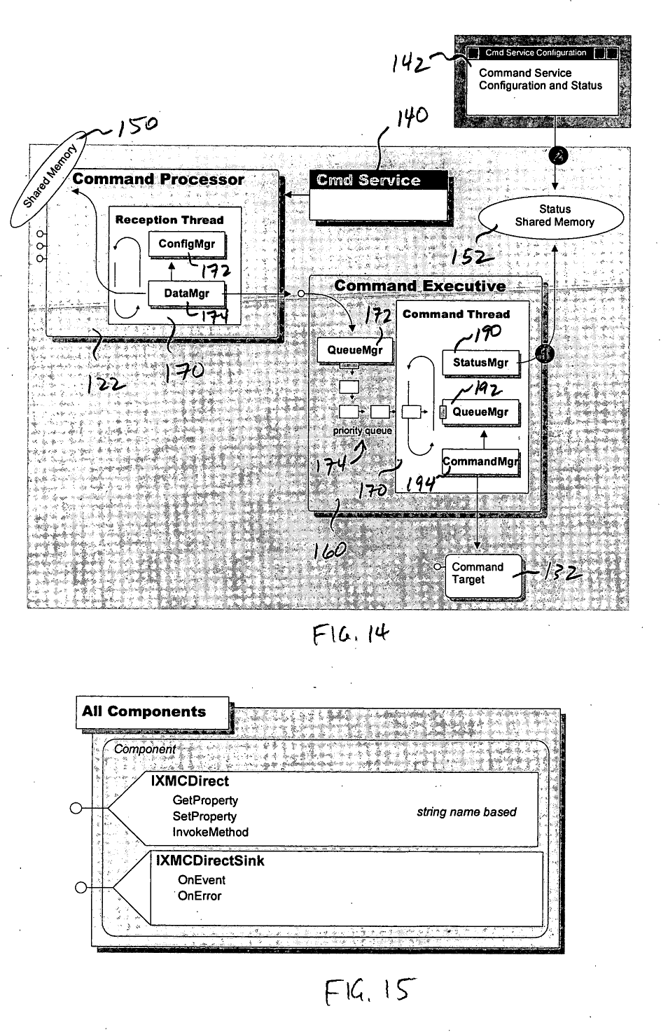

Referring now to FIG. 14, the following steps take place when updating status information while the command processor component 122 and command execution component 160 process commands.

In step 1, during each loop within each command execution component 160 status information is continuously updated using the StatusMgr object 190. For example, the number of commands in the command queue 174 may be set in the status shared memory 152.

The configuration and status module 142 is then able to pick up the information from the shared memory and display it to the user, thus notifying the user of the status of each command execution module 160 (and optionally command processor 122) components. Optionally, a separate thread may be used to monitor status information so as to not slow down or otherwise interfere with the command thread.

As generally described above, the example command processor 122 is a modular system made up of a set of components (i.e. each component is based on a component technology such as OLE/COM from Microsoft Corporation). Optionally, each component uses a separate ‘parallel’ ActiveX component to implement all user interface aspects of the main component. Each ActiveX component may be implemented either within the main component module or separately in its own module. Bundling each object within one module is not required as the objects may be located at any location (i.e. across a network, and so forth), but doing so may optimize communication between modules. The exact location of the components in any given implementation of the present invention is merely a logistical decision. Once components are built and deployed, it is difficult to update a single component if all components are implemented within a single DLL or EXE module.

As shown in FIG. 15, the example components forming the command processor 122 implement, at a minimum, a single interface: the IXMCDirect interface. Optionally, components that receive events from other components can implement the IXMCDirectSink interface as well.

OLE Categories are used to determine how many components fall into a certain group of components. Currently the following categories are used:

command processor components—Typically there is only one command processor component 122. However, in the event that the command processor improves over time and has future more improved versions, each new and improved version would fall into this category of components.

command execution components—command execution components 160 are used to process a set of commands of a given type. For example, the first command target 132a, the second command target 132b, and the third command target 132c represent command types that may each have an associated command execution component 160.

The IXMCDirect interface is used for most communications between all components making up the command processor 122 Technology. The following methods make up this interface (as specified in the standard OLE/COM IDL format):

GetProperty—This method is used to query a specific property from the component implementing the interface.

SetProperty—This method is used to set a specific property from the component implementing the interface.

InvokeMethod—This method is used to invoke a specific action on the component implementing the interface. It should be noted that an action can cause an event to occur, carry out a certain operation, query a value and/or set a value within the component implementing the method.

A more detailed description of each method implemented by the object is described below.

IXMCDirect::GetProperty

| | |
|---|---|
| Syntax | HRESULT GetProperty( LPCTSTR pszPropName, |
| | LPXMC_PARAM_DATA rgData, |
| | DWORD dwCount ); |
| Parameters | LPCTSTR pszPropName - string name of the property to query. |
| | LPXMC_PARAM_DATA rgData - array of XMC_PARAM_DATA |
| | types that specify each parameter corresponding to the property. |
| | For example, a certain property may be made up of a number of |
| | elements - in this case an array of XMC_PARAM_DATA items is |
| | returned, one for each element making up the property. In most |
| | cases a property is made up of a single element, thus a single |
| | element array is passed to this method. For more information on |
| | the XMC_PARAM_DATA type, see below. |
| | DWORD dwCount - number of XMC_PARAM_DATA elements in the |
| | rgData array. |
| Return Value | HRESULT - NOERROR on success, or error code on failure. |

This method is used to query the property corresponding to the property name ‘pszPropName’. Each component defines the properties that it supports.

IXMCDirect::SetProperty

| | |
|---|---|
| Syntax | HRESULT SetProperty( LPCTSTR pszPropName, |
| | LPXMC_PARAM_DATA rgData, |
| | DWORD dwCount ); |
| Parameters | LPCTSTR pszPropName - string name of the property to set. |
| | LPXMC_PARAM_DATA rgData - array of XMC_PARAM_DATA |
| | types that specify each parameter corresponding to the property. |
| | For example, a certain property may be made up of a number of |
| | elements - in this case an array of XMC_PARAM_DATA items is |
| | returned, one for each element making up the property. In most |
| | cases a property is made up of a single element, thus a single |
| | element array is passed to this method. For more information on |
| | the XMC_PARAM_DATA type, see below. |
| | DWORD dwCount - number of XMC_PARAM_DATA elements in the |
| | rgData array. |
| Return Value | HRESULT - NOERROR on success, or error code on failure. |

This method is used to set a property in the component corresponding to the ‘pszPropName’ property. For the set of properties supported by the component, see the specific component description.

IXMCDirect::InvokeMethod

| | |
|---|---|
| Syntax | HRESULT InvokeMethod( DWORD dwMethodIdx, |
| | LPXMC_PARAM_DATA rgData, |
| | DWORD dwCount ); |
| Parameters | DWORD dwMethodIdx - number corresponding to the specific |
| | method to invoke. For more information on the method indexes |
| | available, see the set of namespaces defined for the component. |
| | LPXMC_PARAM_DATA rgData [optional] - array of |
| | XMC_PARAM_DATA types that specify each parameter for the |
| | method called. For more information on the |
| | XMC_PARAM_DATA type, see below. |
| | NOTE: if no parameters exist for the method called, a value of |
| | NULL must be passed in. |
| | DWORD dwCount [optional] - number of XMC_PARAM_DATA |
| | elements in the rgData array. |
| | NOTE: if no parameters exist for the method called, a value of 0 (zero) |
| | must be passed in for this parameter. |
| | LPXMC_PARAM_DATA rgData [optional] - namespace |
| | associated with the instance of the custom extension module added. |
| Return Value | HRESULT - NOERROR on success, or error code on failure. |

This method is used to call a specific method implemented by the component. For more information on the methods supported, see the description of the specific component.

The IXMCDirectSink interface is an event reception point on which one component can send event data to another. The component implementing this interface is the event receiver. The event source calls the interface passing to it event data.

The IXMCDirectSink interface is made up of the following functions.
OnEvent—This method is called by the event source when an event occurs (i.e. the conditions defining the event are met).
OnError—This method is called by the event source when an error occurs.

A more detailed description of each method implemented by the object is described below.

IXMCDirectSink::OnEvent

| | |
|---|---|
| Syntax | HRESULT OnEvent( long lApildx, |
| | SAFEARRAY** ppSA ); |
| Parameters | long lApildx - index associated with the event type.. |
| | SAFEARRAY** ppSA - pointer to a pointer to a SAFEARRAY |
| | containing an array of XMC_PARAM_DATA structures. For |
| | more information on the XMC_PARAM_DATA type, see below. |
| Return Value | HRESULT - NOERROR on success, or error code on failure. |
| Notes | The SAFEARRAY passed to this method contains an array of |
| | XMC_PARAM_DATA structures. This array has the following entries: |
| rgData[0] | LONG IConnectionCookie - unique cookie associated with this |
| | connection to the XMC Motion Server (returned when calling the |
| | InitializeHardware method on the XMC Motion Server). |
| rgData[1] | DWORD dwSubscriptionCookie - unique cookie associated with |
| | the subscription for which this event has fired. This cookie is |
| | returned when making the subscription. |
| rgData[2] | DWORD dwDataCookie - unique cookie associated with the |
| | specific data change that triggered the event. This cookie is |
| | generated within the XMC Motion Server. |
| rgData[3] | LPCTSTR pszItemName - name of the item or variable for which |
| | the subscription is associated. |
| rgData[4] | double dfTimeStamp - number of milliseconds passed from the |
| | time that the event pump, implemented by the XMC Motion |
| | Server, was first started. |
| rgData[5] | DWORD dwDataCount - number of data values associated with |
| | the event (i.e. the number of structure elements that follow). |
| rgData[6 + | Number or String - actual data values associated with the event. |
| n] | |

This method is called by the event source and passed the event data in a SAFEARRAY form for easy marshalling across process boundaries.

IXMCDirectSink::OnError

| | |
|---|---|
| Syntax | HRESULT OnError( long IApiIdx, |
| | SAFEARRAY** ppSA ); |
| Parameters | long lApildx - index associated with the event type.. |
| | SAFEARRAY** ppSA - pointer to a pointer to a SAFEARRAY |
| | containing an array of XMC_PARAM_DATA structures. For |
| | more information on the XMC_PARAM_DATA type, see below. |
| Return Value | HRESULT - NOERROR on success, or error code on failure. |
| Notes | The SAFEARRAY passed to this method contains an array of |
| | XMC_PARAM_DATA structures. This array has the following entries: |
| rgData[0] | LONG lConnectionCookie - unique cookie associated with this |
| | connection to the XMC Motion Server (returned when calling the |
| | InitializeHardware method on the XMC Motion Server). |
| rgData[1] | DWORD dwSubscriptionCookie - unique cookie associated with |
| | the subscription for which this event has fired. This cookie is |
| | returned when making the subscription. |
| rgData[2] | DWORD dwDataCookie - unique cookie associated with the |
| | specific data change that triggered the event. This cookie is |
| | generated within the XMC Motion Server. |
| rgData[3] | LPCTSTR pszItemName - name of the item or variable for which |
| | the subscription is associated. |
| rgData[4] | double dfTimeStamp - number of milliseconds passed from the |
| | time that the event pump, implemented by the XMC Motion |
| | Server, was first started. |
| rgData[5] | HRESULT hrResult - result code of the error for which the event |
| | is associated. |
| rgData[6] | LPCTSTR pszError - string description of the error. |
| rgData[7] | LONG ISrcError - error code describing the source of the error. |
| | For example, this may be an error code returned by a computer |
| | controlled piece of hardware. |
| rgData[8] | LPCTSTR pszSrcError - string describing the source error. |

This method is called by the event source when an error occurs and passed the event error data in a SAFEARRAY form for easy marshalling across process boundaries.

The methods supported by each component making up the system 120 will now be described. In particular, the methods supported by the majority of the components will be described below. For the specific list of methods supported by each component, see the section describing each component.

XMC_CP_SYSTEM_CONNECT_CMPNT

| | |
|---|---|
| Index | 8000 |
| Data In | rgData[0] - (number) DWORD, type of component. The type |
| | of component is a value that is server specific. For |
| | component type information, see the description |
| | for this method under each |
| | server's description. |
| | rgData[1] - (string) LPTSTR, component class id as an |
| | ASCII string. |
| Data Out | None. |

This method is used to connect one server to another so that they may interact with one another.

XMC_CP_SYSTEM_DISCONNECT_CMPNT

| | |
|---|---|
| Index | 8001 |
| Data In | rgData[0] - (number) DWORD, type of component. The type |
| | of component is a value that is server specific. For |
| | component type information, see the description for this |
| | method under each server's description. |
| | rgData[1] - (string) LPTSTR, component class id as an |
| | ASCII string. |
| Data Out | None. |

This method is used to disconnect one server to another so that they stop interacting with one another.

XMC_CP_PROCESS_START

| | |
|---|---|
| Index | 8500 |
| Data In | None. |
| Data Out | None. |

This method is called to start the command processor technology making it ready to process commands.

XMC_CP_PROCESS_ENABLE

| | |
|---|---|
| Index | 8501 |
| Data In | rgData[0] - (number) BOOL - TRUE enables the command |
| | processor, FALSE disables it. The command processor only |
| | processes commands when it is enabled. |
| Data Out | None. |

This method is used to configure what type of data is returned when processing a given data item. For example in the server may be configured to return the minimal amount of data on each read (i.e. just the data item value), or the server may be requested to return more substantial data.

XMC_CP_PROCESS_STOP

| | |
|---|---|
| Index | 8061 |
| Data In | None. |
| Data Out | None. |

This method is called to shut-down the command processor.

XMC_DE_EVENT_ENABLE

| | |
|---|---|
| Index | 2892 |
| Data In | rgData[0] - (number) DWORD, cookie (unique identifier) |
| | associated with the subscription. This value is returned to the |
| | service client 34 when calling the subscription COMMAND |
| | SOURCE #1 above. |
| | NOTE: using a cookie value of zero (0) will enable/disable |
| | ALL items subscribed to the server. |
| | rgData[1] - (number) BOOL, TRUE to enable the |
| | subscription(s), FALSE to disable the subscription(s). |
| | Only enabled subscriptions actually fire events. |
| Data Out | None. |

This method enables/disables a previously subscribed data item in the subscription list maintained by the server. Only enabled subscriptions actually fire.

XMC_DE_EVENT_RECEIVE_DATA

| | |
|---|---|
| Index | 8045 |
| Data In | rgData[0] - (number) DWORD, subscription cookie |
| | corresponding to the subscribed data item. |
| | rgData[1] - (number or string), data item value. |
| | rgData[2] - (OPTIONAL number) DWORD, data item time- |
| | stamp as a system time value. |
| | rgData[3] - (OPTIONAL string) LPSTR, data item ASCII text |
| | name. |
| | rgData[4] - (OPTIONAL number) DWORD, data item unique |
| | cookie. |
| | NOTE: Since the last three items are optional, only those |
| | items specified when configuring the data to receive |
| | are actually sent. If, for example, one or more |
| | data items are NOT requested, then the |
| | items are returned in slots shifted up toward rgData[1]. For |
| | example if only the data item name is requested in addition |
| | to the default data items, the data returned |
| | would look like the following: |
| | rgData[0] - (number) DWORD, subscription cookie. |
| | rgData[1] - (number or string), data item value. |
| | rgData[2] - (string) LPSTR, data item name. |
| Data Out | None. |

This method is called by the server (and implemented by the service client 34) when each subscribed event fires.

XMC_DE_EVENT_RECEIVE_DATA_CONFIGURE

| | |
|---|---|
| Index | 8044 |
| Data In | rgData[0] - (number) DWORD, flag describing the type of |
| | data to be returned on each event. |
| | The following flags are supported: |
| | XMC_DE_EVENT_DATA_FLAG_TIMESTAMP - |
| | requests that the time stamp recorded |
| | when reading the data is returned. |
| | XMC_DE_EVENT_DATA_FLAG_NAME - |
| | requests that the data items ASCII text name be returned. |
| | XMC_DE_EVENT_DATA_FLAG_DATA_COOKIE - |
| | requests that the unique data item cookie corresponding |
| | to the read made for the data item be returned. |
| | NOTE: by default, the subscription cookie and data item |
| | value are always returned. |
| Data Out | None. |

This method is used to configure what type of data is returned on each event that is fired. For example in the server may be configured to send the minimal amount of data on each event (i.e. subscription cookie and data item value), or the server may be requested to return more substantial data.

XMC_DE_EVENT_SUBSCRIBE

| | |
|---|---|
| Index | 2890 |
| Data In | rgData[0] - (number) DWORD, flags describing the initial state of |
| | the subscription. The following flags are supported: |
| | XMC_DE_EVENT_FLAG_ENABLED - subscription is |
| | immediately enabled upon subscription. |
| | XMC_DE_EVENT_FLAG_DISABLED - subscription is disabled |
| | upon making the subscription. The Enable function must be |
| | called to enable the subscription. |
| | rgData[1] - (number) DWORD, number of subscription criteria |
| | rules. |
| | rgData[2 + (2*n)] - (number) DWORD, event condition type where |
| | the following types are supported: |
| | XMC_CNC_EVENTCONDITION_DATA_CHANGE - any data |
| | changes in the data type above will trigger the event. |
| | XMC_CNC_EVENTCONDITION_DATA_EQUAL |
| | XMC_CNC_EVENTCONDITION_DATA_LESSTHAN |
| | XMC_CNC_EVENTCONDITION_DATA_GREATERTHAN |
| | XMC_CNC_EVENTCONDITION_DATA_AND |
| | XMC_CNC_EVENTCONDITION_DATA_OR |
| | Each of the conditions above are used in a combined manner. |
| | Where the logical condition (=, <, >) are applied for each type respectively. |
| | For example, in an array that contains the following items: |
| | rgData[2] = 4 (4 condition values) |
| | rgData[3] = XMC_CNC_EVENTCONDITION_EQUAL |
| | rgData[4] = 3.0 |
| | rgData[5] = XMC_CNC_EVENTCONDITION_LESSTHAN |
| | rgData[6] = 3.0 |
| | rgData[7] = XMC_CNC_EVENTCONDITION_OR |
| | rgData[8] = 1.0 |
| | rgData[9] = XMC_CNC_EVENTCONDITION_GREATHERTHAN |
| | rgData[10] = 5.0 |
| | the array would be evaluated using the following logic: |
| | If (DATA <= 3.0 OR DATA > 5.0) then Trigger Event |
| | rgData[3 + (2*n)] - (number) double, the value for the condition. |
| | See above. |
| Data Out | rgData[0] - (number) DWORD, cookie (unique identifier) |
| | representing the subscription. |

This method subscribes to a given data item activating the event interface when the subscription criteria are met for the data item. In the example system 120, all ubscribing components must use the IXMCDirect interface to receive events received from the server for which they are subscribed.

XMC_DE_EVENT_UNSUBSCRIBE

| | |
|---|---|
| Index | 2891 |
| Data In | rgData[0] - (number) DWORD, cookie (unique identifier) |
| | associated with the subscription. This value is returned to the |
| | service client 34 when calling the subscription COMMAND |
| | SOURCE #1 above. |
| | NOTE: using a cookie value of zero (0) will unsubscribe |
| | ALL items subscribed to the server. |
| Data Out | None. |

This method removes a previously subscribed data item from the subscription list maintained by the server.

XMC_DE_SYSTEM_INITIALIZEHW

| | |
|---|---|
| Index | 500 |
| Data In | None. |
| Data Out | None. |

This method is used to initialize any hardware systems associated with the component.

XMC_DE_SYSTEM_SHUTDOWNHW

| | |
|---|---|
| Index | 501 |
| Data In | None. |
| Data Out | None. |

This method is used to shut down any hardware systems associated with the component.

The command processor component 122 implements the following general methods listed above.

| | | Not |
|---|---|---|
| Method | Implemented | Implemented |
| XMC_CP_PROCESS_START | X | x |
| XMC_CP_PROCESS_ENABLE | X | x |
| XMC_CP_PROCESS_STOP | X | |
| XMC_DE_EVENT_ENABLE | X | |
| XMC_DE_EVENT_RECEIVE_DATA | X | |
| XMC_DE_EVENT_RECEIVE_DATA_CONFIGURE | X | |
| XMC_DE_EVENT_SUBSCRIBE | X | |
| XMC_DE_EVENT_UNSUBSCRIBE | X | |
| XMC_DE_SYSTEM_CONNECT_CMPNT | X | |
| XMC_DE_SYSTEM_DISCONNECT_CMPNT | X | |
| XMC_DE_SYSTEM_INITIALIZEHW | X | |
| XMC_DE_SYSTEM_SHUTDOWNHW | X | |

There are no special notes for the methods that this component implements.

The command execution components 160 implement the following general methods listed in the general component methods section above.

| | | Not |
|---|---|---|
| Method | Implemented | Implemented |
| XMC_CP_PROCESS_START | | X |
| XMC_CP_PROCESS_ENABLE | | X |
| XMC_CP_PROCESS_STOP | | X |
| XMC_DE_EVENT_ENABLE | X | |
| XMC_DE_EVENT_RECEIVE_DATA | X | |
| XMC_DE_EVENT_RECEIVE_DATA_CONFIGURE | X | |
| XMC_DE_EVENT_SUBSCRIBE | X | |
| XMC_DE_EVENT_UNSUBSCRIBE | X | |
| XMC_DE_SYSTEM_CONNECT_CMPNT | | X |
| XMC_DE_SYSTEM_DISCONNECT_CMPNT | | X |
| XMC_DE_SYSTEM_INITIALIZEHW | X | |
| XMC_DE_SYSTEM_SHUTDOWNHW | X | |

There are no special notes for the methods that this component implements.

The definitions of all special types used by the methods and properties of each component making up the command processor system 122 will now be described.

XMC_PARAM_DATA Structure

All methods exposed by each component in the example system 122 use a standard parameters set to describe data used to set and query properties as well as invoke methods. The standard parameters are in the following format:
pObj->InvokeMethod(LPXMC_PARAM_DATA rgData, DWORD dwCount);

Each element in the rgData array corresponds to a parameter, with the first element in the array corresponding to the first parameter.

The XMC_PARAM_DATA structure can contain either a numerical or a string value and is defined as follows:

```
typedef struct tagXMC_PARAM_DATA
{
  LNG_PARAM_DATATYPE adt;
  union
  {
    double df;
    LPTSTR psz;
  };
}XMC_PARAM_DATA;
```

The ‘adt’ member of the XMC_PARAM_DATA structure describes the data contained within the XMC_PARAM_DATA structure. The values are described below:

| LNG_PARAM_DATATYPE | Description |
|---|---|
| LNG_ADT_NUMBER | Use this value when passing a numerical value |
| | via the ‘adt’ member of the |
| | XMC_PARAM_DATA structure. |
| LNG_ADT_STAT_STRING | Use this value when passing a static string value |
| | via the ‘psz’ member of the |
| | XMC_PARAM_DATA structure. Static |
| | strings do not need to be freed from memory. |
| LNG_ADT_MEM_STRING | Use this value when passing a string value via |
| | the ‘psz’ member of the XMC_PARAM_DATA |
| | structure. LNG_ADT_MEM_STRING denotes |
| | that the string must be freed from memory during cleanup. |
| LNG_ADT_NOP | This value is used to ignore items within the |
| | XMC_PARAM_DATA array. When specifies, this |
| | parameter is not used. |

When querying and setting boolean TRUE/FALSE values, any non-zero value is considered TRUE, whereas a zero value is considered FALSE.

The command processor 122 of the present invention may be used on more than just motion based devices and machines, although the present invention is of particular significance in that environment. The principles of the present invention may also be used to send commands to medical devices where each command directs the medical device to carry out a set of operations. It may also be used to send commands to farming equipment, heavy machinery such as tractors, excavators, bulldozers, cranes, semi-trucks, automobiles, drilling equipment, water craft such as submersibles, boats and ships, airplanes (including jets), spacecraft, satellites, and any other kind of mobile device or machine that moves on land, water or within the air or space.

The technology implemented by the present invention may be used to send commands in the following environments:
office equipment such as printers, fax machines, telephone systems, internet routers, internet firewalls and security cameras and general security systems.
general consumer devices such as home entertainment systems, televisions, microwaves, ovens, refrigerators, washers and driers, vacuums, hand held music systems, personal digital assistants, toys, musical instruments, etc.
yard items such as lawn mowers, yard care devices, snow blowers, air blowers, edger's, etc.
military equipment such as drone airplanes, drone tanks, drone land mobiles, drone boats, tanks, ships, jets and any other mobile or stationary devices used on land, sea or in the air or space.
various types of factory equipment that may or may not use motion to carry out its task, such as i/o devices, analog devices, CNC machines, General Motion machines, FMS machines, measuring systems, etc.
animatronics devices such as robot dogs, robotic mannequins, robotic helpers, or other robotic human-like or robotic animal like devices.

The term “command data” as used herein refer to any numeric or string data values used to describe the command and parameters describing how to perform the command. For example, BIT, BYTE, WORD, DWORD, LONG, REAL, DOUBLE, FLOAT, STRING, ASCII STRING are a few command data types that represent commands and/or command parameters. Command data may eventually be sent to the command target by writing register values on the command target, writing to shared memory provided by the command target, sending commands to the command target for which a data response is given containing the data requested, writing to variables provided by the command target, reading and writing to variables in a sequence necessary to carry out the commanded operation, using a proprietary or standard data protocol, calling a function provided by the command target, etc.

From the foregoing, it should be apparent that the invention may be embodied in forms other than those described above. The scope of the present invention should thus be determined by the following claims and not the foregoing detailed description of the invention.

1. A command processing system for transferring commands from at least one command source to at least one command target of at least one command target type, comprising:
a command processor in communication with the at least one command source; and
a command thread associated with each command target type; wherein
the command thread is in communication with the command processor,
the command thread is in communication with at least one command target;
the command source transfers commands to the command processor; and
the command thread transfers commands from the command processor to the command target.
